(19) United States
(12) Patent Application Publication
(10) Pub. No.: US 2008/0313075 A1
(43) Pub. Date: Dec. 18, 2008

(54) PAYMENTS-DRIVEN DYNAMIC FIREWALLS AND METHODS OF PROVIDING PAYMENTS-DRIVEN DYNAMIC ACCESS TO NETWORK SERVICES

(75) Inventors: Mahesh V. TRIPUNITARA, Elgin, IL (US); Dean H. Vogler, Algonquin, IL (US)

Correspondence Address: PRASS LLP, 2661 Riva Road, Bldg. 1000, Suite 1044, ANNAPOLIS, MD, 21401, US

(73) Assignee: Motorola, Inc., Schaumburg, IL (US)

(21) Appl. No.: 11/762,444

(22) Filed: Jun. 13, 2007

(51) Int. Cl. G06Q 40/00

(52) U.S. Cl. 705/39

(57) ABSTRACT

A machine-implemented method of providing dynamic access to network services may include receiving a request from a client for a type of network service, monitoring an amount and type of network service being provided to the client, and receiving incremental payments from the client for the network service being provided as the network service continues to be provided. The method may include dynamically modifying access to the network service for the client based on a set of rules. The rules may be based on one or more of the monitored amount of network service, the type of network service, and the payments received.

### TECHNICAL FIELD

The present invention is directed to dynamic firewalls and methods of providing dynamic access to network services. More particularly, the present invention is directed to dynamic firewalls and methods for providing dynamic access to network services that are suitable for micropayments for relatively small units of time or data and/or for specific network services.

### BACKGROUND

Various conventional approaches exist for enforcing payments for network access. Some approaches use a conventional firewall. For example, a user must pay for network access before being granted access. If the user attempts to gain network access before paying, the user is redirected to a proxy server. The proxy server serves up web pages that request payment credentials from the user, such as, for example, credit card information or the like. After the user enters payment credentials, the credentials are validated online, and the firewall is opened so that the user can access the network.

With such conventional firewalls, the access to network services is typically coarse-grained. For example, coarse-grained access permits access to all or a wide spectrum of services, such as, for example, www, pop/imap, and dns. Coarse-grained access also typically allows access for a substantial period of time, such as, for example, full day, half day, four hours, and the like. Such coarse-grained access may result in significant waste in situations where the user only needs www access and not pop/imap or vice versa, or where the user only need a few minutes of access.

Thus, it may be desirable to provide dynamic firewalls and methods of providing dynamic access to network services so as to provide the user with the ability to customize the scope of access to network services in the amount of time, the amount of data, and/or the type of data that the user desires to access. It may be desirable to provide dynamic firewalls and methods for supporting continuous, fine-grained, automated payments for network services.

### SUMMARY OF THE INVENTION

According to various aspects of the disclosure, a machine-implemented method of providing dynamic access to network services may include receiving a request from a client for a type of network service, monitoring an amount and type of network service being provided to the client, receiving incremental payments from the client for the network service being provided as the network service continues to be provided, and dynamically modifying access to the network service for the client based on a set of rules. The rules may be based on one or more of the monitored amount of network service, the type of network service, and the payments received.

In accordance with some aspects of the disclosure, a processing device may comprise at least one processor, a memory including instructions for the processor, and a bus for providing communication between the processor and the memory. The memory may further comprise instructions for receiving a request from a client for a type of network service, for monitoring an amount and type of network service being provided to the client, for receiving incremental payments from the client for the network service being provided as the network service continues to be provided, and instructions for dynamically modifying access to the network service for the client based on a set of rules. The rules may be based on one or more of the monitored amount of network service, the type of network service, and the payments received.

In some aspects of the disclosure, a tangible, machine-readable medium may have instructions for at least one processor recorded thereon. The medium may comprise instructions for receiving a request from a client for a type of network service, instructions for monitoring an amount and type of network service being provided to the client, instructions for receiving incremental payments from the client for the network service being provided as the network service continues to be provided, and instructions for dynamically modifying access to the network service for the client based on a set of rules. The rules may be based on one or more of the monitored amount of network service, the type of network service, and the payments received.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an exemplary diagram of a payments-driven dynamic firewall operating in a communications network environment in accordance with a possible embodiment of the invention;

FIG. 2 illustrates a block diagram of an exemplary communication device having a payments-driven dynamic firewall in accordance with a possible embodiment of the invention;

FIG. 3 is a block diagram showing exemplary modules of an exemplary payments-driven dynamic firewall in accordance with a possible embodiment of the invention; and

FIG. 4 is an exemplary flowchart illustrating one possible process for providing dynamic access to network services in accordance with one possible embodiment of the invention.

### DETAILED DESCRIPTION

Additional features and advantages of the invention will be set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth herein.

Various embodiments of the invention are discussed in detail below. While specific implementations are discussed, it should be understood that this is done for illustration purposes only. A person skilled in the relevant art will recognize that other components and configurations may be used.

The present invention comprises a variety of embodiments, such as methods and apparatus and other embodiments that relate to the basic concepts of the invention.

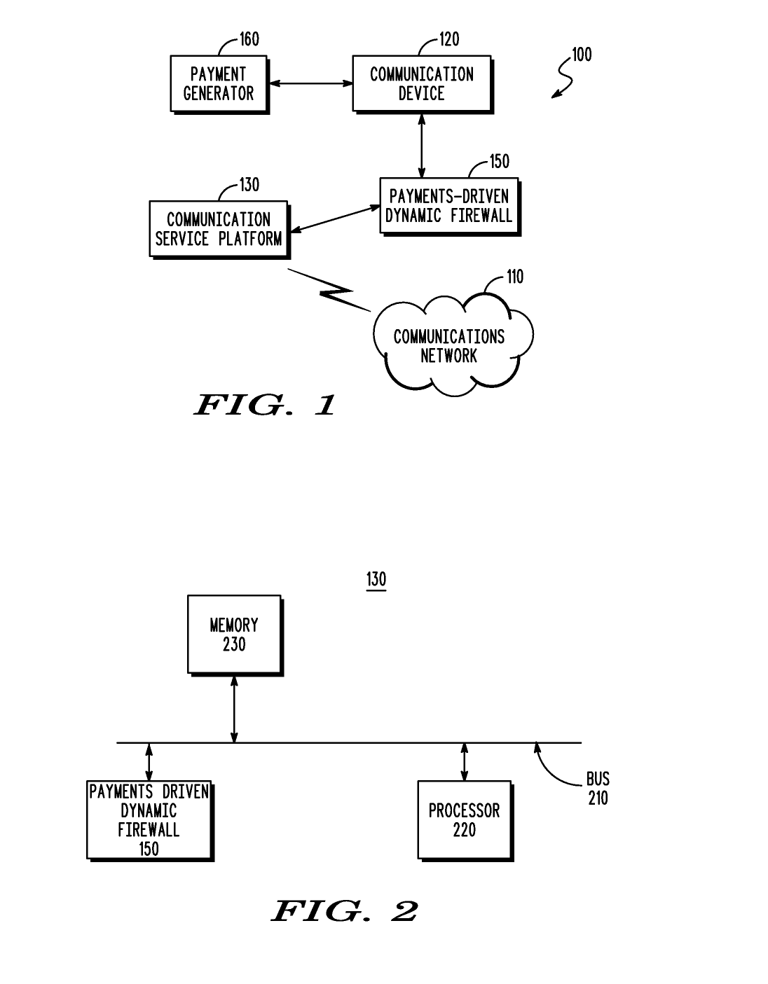

FIG. 1 illustrates a payments-driven dynamic firewall 150 operating in a communications network environment 100. The communications network environment 100 includes a communications network 110, a communication device 120, a communication service platform 130, and a payment generator 160. The payment generator 160 may be associated with the communication device 120. The payments-driven dynamic firewall 150 may permit the communication device 120 to communicate with the communications network 110 via the communication service platform 130.

Communications network 110 may represent any network known to one of skill in the art, including a wireless telephone network, cellular network, a wired telephone network, the Internet, wired computer network, wireless computer network, intranet, satellite radio network, etc. Communication device 120 may represent wireless telephones, wired telephones, personal computers, portable radios, personal digital assistants (PDAs), MP3 players, satellite radio, satellite television, a global positioning system (GPS) receiver, etc. It should be appreciated that the communications network 110 may include a plurality of communication devices of the same or a different type.

The communications network 110 may allow the communication device 120 to communicate with the communications service platform 130, which may provide various network services, such as, media content, navigation, directory information, etc. The communication service platform 130 may comprise the infrastructure at a vendor that provides access to the communications network 110 and the services, such as, for example, music streaming, video streaming, web browsing, etc. The network service may be provided via any protocol, including, but not limited to, http, ftp, ssh, and pop/imap. The communication device 120 may communicate through communications network 110 with other communication devices.

FIG. 2 illustrates a block diagram of an exemplary communication service platform 130 having a payments-driven dynamic firewall 150 in accordance with a possible embodiment of the invention. The exemplary communication service platform 130 may include a bus 210, a processor 220, a memory 230, and the dynamic firewall module 150. Bus 210 may permit communication among the components of the communication service platform 130.

Processor 220 may include at least one conventional processor or microprocessor that interprets and executes instructions. Memory 230 may be a random access memory (RAM) or another type of dynamic storage device that stores information and instructions for execution by processor 220. Memory 230 may also include a read-only memory (ROM) which may include a conventional ROM device or another type of static storage device that stores static information and instructions for processor 220.

It should be appreciated that the processor 220 may be cooperatively operable with a transceiver (not shown) to support operations within the communications network 110. Similarly, a communication interface (not shown) may facilitate communication via the communications network 110.

The wireless communication device 120 may perform such functions in response to processor 220 by executing sequences of instructions contained in a computer-readable medium, such as, for example, memory 230. Such instructions may be read into memory 230 from another computer-readable medium, such as a storage device or from a separate device.

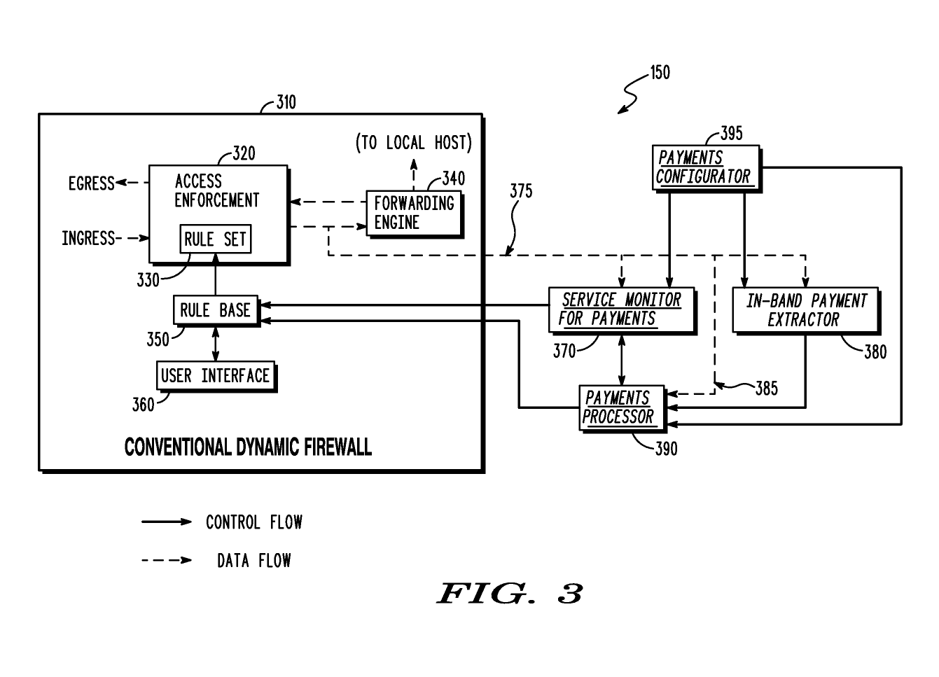

FIG. 3 illustrates a block diagram of an exemplary payments-driven dynamic firewall 150 in accordance with a possible embodiment of the invention. In FIG. 3, solid lines indicate control flow, and dashed lines indicate data flow. The payments-driven dynamic firewall 150 may include a conventional dynamic firewall 310, as would be understood by persons skilled in the art.

For example, the conventional dynamic firewall 310 may comprise an access enforcement module 320 that performs ingress and egress filtering based on a defined rule set 330. Ingress filtering is performed immediately as data traffic enters the base firewall module 310 and egress filtering is performed just before data traffic is about to exit the base firewall module 310. The conventional dynamic firewall 310 may include a forwarding engine 340 configured to perform filtering just before and after the conventional dynamic firewall 310 makes a decision as to the interface via which the traffic is to be forwarded. The aforementioned filters may be put into place prior to deployment and are not reactive to the type of data payloads seen through the network. The conventional dynamic firewall 310 may include a rule base 350 that permits a client to modify performance of the conventional dynamic firewall 310 and a user interface 360 that facilitates access to the conventional dynamic firewall 310.

In addition to the base firewall module 310, the payments-driven dynamic firewall 150 may include a service monitor for payments 370, an in-band payment extractor 380, a payments processor 390 in communication with the service monitor 370 and the extractor 380, and a payments configurator in communication with the service monitor 370, the in-band payment extractor 380, and the payments processor 390.

Data that passes access enforcement 375 may include payment information, service information, and the like. The payment information may include payments for services on behalf of a user. Such payment information may be in-band or out-of-band. In-band payments are intermingled with other data traffic, such as, for example, data traffic associated with the network service for which payments are being made. The in-band payment extractor 380 is configured to extract payment information from data traffic. After extracting the payment information, the in-band payment extractor 380 communicates the payment information to the payments processor 390.

Out-of-band payments are those made via a channel, session, or connection 385 separate from data traffic. Out-of-band payments are included in the data that passes access enforcement 375, but are processed directly by the payments processor 390.

The service monitor for payments 370 may be used to monitor service usage and the rule base 350 so that it can allow particular kinds of traffic that pertain to a service. For example, if a user requests a music service, the service monitor 370 may instruct the rule base 350 to open up the firewall so that the user can stream music. The service monitor 370 may also inform the payments processor 390 that the user needs to pay for streaming music service. When the user ceases using the streaming music service, the service monitor 370 may instruct the rule base 350 to close the user's access to the streaming music service. Another example is when the user pays for seconds of streaming audio or video. In this case, the service monitor 370 may look for particular commands from the user, such as, for example, play, pause, or tear-down in the real-time streaming protocol.

The payments processor 390 may be used to process payments when they are received and to modify the rule base 350 in situations where a user does not meet payment obligations. For example, if an invalid payment token is received from a user, the payments processor 390 may immediately instruct the rule base 350 to cut off service for the user. The payments processor 390 may also maintain an appropriate state for each payment session and ensure that payments are for the correct amount and have the correct syntax so that, for example, a user does not exceed defined payment terms or get more service than has been paid for. For example, if the user has to pay a penny for every 10 Kbytes of web access, the service monitor 370 counts the number of bytes of web traffic and informs the payments processor 390 every time the user crosses the 10 Kbyte threshold. The payments processor 390 may then instruct the rule base 350 to close the user's web access if sufficient payment has not been received. The payments processor 390 may use auxiliary helper functions such as, for example, a cryptographic toolkit, to verify a signature and/or cryptographic hash.

The payments configurator 395 may comprise a user-interface that can be used for configuring the service monitor for payments 370, the in-band payment extractor 380, and the payments processor 390. For example, the payments configurator 395 can be used to tell the service monitor 370 the kind of monitoring it should perform for a particular service. According to one exemplary aspect, the payments configurator 395 can inform the service monitor 370 that a payment is expected every 10 Kbytes of web (i.e., www) traffic. The payments configurator 395 may be made available as an Application Programmer Interface (API) so that the service monitor 370, payment extractor 380, and payments processor 390 can be controlled programmatically.

The communications network 110, the communication service platform 130, and the payments-driven dynamic firewall 150 illustrated in FIGS. 1-3 and the related discussion are intended to provide a brief, general description of a suitable computing environment in which the invention may be implemented. Although not required, the invention will be described, at least in part, in the general context of computer-executable instructions, such as program modules, being executed by the communication service platform 130, such as a communications server or general purpose computer. Generally, program modules include routine programs, objects, components, data structures, etc. that perform particular tasks or implement particular abstract data types. Moreover, those skilled in the art will appreciate that other embodiments of the invention may be practiced in communication network environments with many types and combinations of communication equipment and computer system configurations, including cellular devices, mobile communication devices, personal computers, hand-held devices, multi-processor systems, microprocessor-based or programmable consumer electronics, and the like.

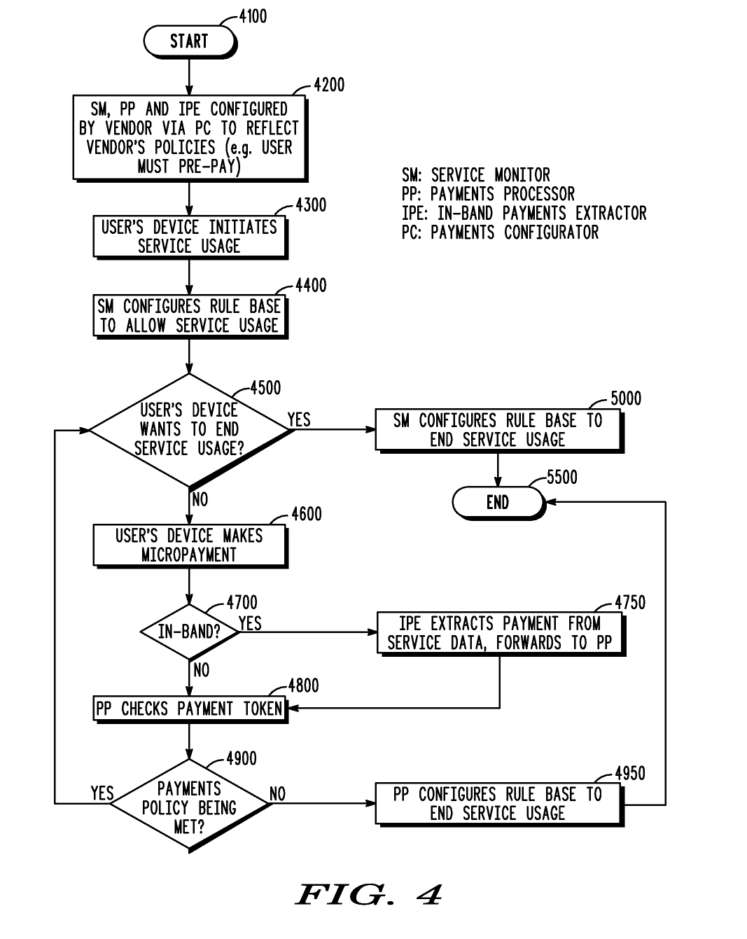

For illustrative purposes, an exemplary dynamic firewall process will be described below in relation to the block diagrams shown in FIGS. 1-3. FIG. 4 is an exemplary flowchart illustrating some of the basic steps associated with an exemplary process for providing dynamic access to network services in accordance with a possible embodiment of the invention. The process begins at step 4100 when a user or client initiates a new service instance or request for which the client needs to begin making payments as it uses the service. Control proceeds to step 4200.

In step 4200, the service monitor 370, the payments processor 390, and the in-band payment extractor 380 may be configured by a vendor via the payments configurator 395 to reflect the vendor's service policies. The vendor's policies may include, for example, whether a user must prepay, the payment amount per unit for each service type, and the like. This configuration may be done dynamically; that is, while the network is live and data traffic is flowing, the configurations of the components of the payments-driven dynamic firewall 150 can be changed. Control then continues to step 4300.

Next, in step 4300, a user initiates a service usage request via the communication device 120. Control then proceeds to step 4400, where the service monitor 370 instructs the rule base 350 to allow service usage by the user. Control continues to step 4500.

If, in step 4500, it is determined that the user's device has requested an end to service usage, control skips to step 5000, where the service monitor 370 instructs the rule base to end service usage for the user. Control then continues to step 5500 where the process ends.

Otherwise, if it is determined in step 4500 that the user's device does not want to end service usage (i.e., continued service is desired), control proceeds to step 4600. In step 4600, the user's communication device 120 makes a payment, for example, a micropayment. Control continues to step 4700.

If, in step 4700, it is determined that payments are being made in-band, control proceeds to step 4750, where the in-band payment extractor 380 extracts payment information from the data traffic and forwards the payment information to the payments processor 390. Control then continues to step 4800

Otherwise, if it is determined in step 4700 that payments are not being made in-band (i.e., payments are being made out-of-band), control proceeds to step 4800. In step 4800, the payments processor 390 checks the payment information, for example, a payment token, received from the user's communication device 120. Control then continues to step 4900.

If, in step 4900, it is determined that the vendor's payment policies are being met, control returns to step 4500, where service continues to be provided to the user's device 120 as long as desired and as long as payments are being made.

Otherwise, if it is determined in step 4900 that the vendor's payment policies are not being met, control proceeds to step 4950. In step 4950, the payments processor 390 instructs the rule base 350 to end service usage for the user's communication device 120. Control then continues to step 5500 where the process ends.

Embodiments within the scope of the present disclosure may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

It is noted that, as used in this specification and the appended claims, the singular forms “a,” “an,” and “the,” include plural referents unless expressly and unequivocally limited to one referent. Thus, for example, reference to “a user input” includes two or more different user inputs. As used herein, the term “include” and its grammatical variants are intended to be non-limiting, such that recitation of items in a list is not to the exclusion of other like items that can be substituted or other items that can be added to the listed items.

It will be apparent to those skilled in the art that various modifications and variations can be made in the devices and methods of the present disclosure without departing from the scope of the invention. Other embodiments of the invention will be apparent to those skilled in the art from consideration of the specification and practice of the invention disclosed herein. It is intended that the specification and examples be considered as exemplary only.

What is claimed is:

1. A machine-implemented method of providing dynamic access to network services, the method comprising:
receiving a request from a client for a type of network service;
monitoring an amount and type of network service being provided to the client;
receiving incremental payments from the client for the network service being provided as the network service continues to be provided; and
dynamically modifying access to the network service for the client based on a set of rules, wherein the rules are based on one or more of the monitored amount of network service, the type of network service, and the payments received.

2. The method of claim 1, further comprising determining whether the incremental payments are being made in-band or out-of-band.

3. The method of claim 2, wherein when the payments are being made in-band, the method further comprises extracting payment data from data traffic of the network service being provided.

4. The method of claim 2, wherein when the payments are being made out-of-band, the method further comprises directly processing packets of payment data.

5. The method of claim 1, wherein the incremental payments comprise micropayments.

6. The method of claim 1, further comprising determining when the amount and type of network service provided exceeds the amount and type of network service paid for, and ceasing the providing of the network service to the client.

7. A processing device, comprising:
at least one processor;
a memory including instructions for the processor; and
a bus for providing communication between the processor and the memory, the memory further comprising instructions for receiving a request from a client for a type of network service, for monitoring an amount and type of network service being provided to the client, for receiving incremental payments from the client for the network service being provided as the network service continues to be provided, and for dynamically modifying access to the network service for the client based on a set of rules, wherein the rules are based on one or more of the monitored amount of network service, the type of network service, and the payments received.

8. The device of claim 7, wherein the memory further comprises instructions for determining whether the incremental payments are being made in-band or out-of-band.

9. The device of claim 8, wherein the memory further comprises instructions such that when the payments are being made in-band, payment data is extracted from data traffic of the network service being provided.

10. The device of claim 8, wherein the memory further comprises instructions such that when the payments are being made out-of-band, packets of payment data are processed directly.

11. The device of claim 7, wherein the incremental payments comprise micropayments.

12. The device of claim 7, further comprising instructions for determining when the amount and type of network service provided exceeds the amount and type of network service paid for, and ceasing the providing of the network service to the client.

13. A tangible, machine-readable medium having instructions for at least one processor recorded thereon, the medium comprising:
instructions for receiving a request from a client for a type of network service;
instructions for monitoring an amount and type of network service being provided to the client;
instructions for receiving incremental payments from the client for the network service being provided as the network service continues to be provided; and
instructions for dynamically modifying access to the network service for the client based on a set of rules, wherein the rules are based on one or more of the monitored amount of network service, the type of network service, and the payments received.

14. The medium of claim 13, further comprising instructions for determining whether the incremental payments are being made in-band or out-of-band.

15. The medium of claim 14, wherein the medium further comprises instructions such that when the payments are being made in-band, payment data is extracted from data traffic of the network service being provided.

16. The medium of claim 14, wherein the medium further comprises instructions when the payments are being made out-of-band, packets of payment data are processed directly.

17. The medium of claim 13, wherein the incremental payments comprise micropayments.

18. The medium of claim 13, further comprising instructions for determining when the amount and type of network service provided exceeds the amount and type of network service paid for, and ceasing the providing of the network service to the client.
